(19) United States
(12) Patent Application Publication
(10) Pub. No.: US 2006/0253839 A1
(43) Pub. Date: Nov. 9, 2006

(54) Generating performance tests from UML specifications using markov chains

(76) Inventors: Alberto Avritzer, Mountainside, NJ (US); Marlon E. R. Vieira, East Windsor, NJ (US)

Correspondence Address: Siemens Corporation;Intellectual Property Department, 170 Wood Avenue South, Iselin, NJ, 08830, US

(21) Appl. No.: 11/386,971

(22) Filed: Mar. 22, 2006

Related U.S. Application Data
(60) Provisional application No. 60/666,399, filed on Mar. 30, 2005.

(51) Int. Cl. G06F 9/44

(52) U.S. Cl. 717/124

(57) ABSTRACT

An automated approach to generating test cases for performance testing may be used for test case planning, early in the software development process, when a UML use case model and its activity diagram refinement are specified. The planned performance tests are executed later in the software development process, after the system is developed. The use case model is annotated with operation arrival rates and departure rates. Deterministic state testing (DST) generation and execution are applied for performance test generation and execution. In addition, a technique is described to generate the most likely test scenarios, labeling each arch in the activity diagram with transition probabilities and applying a breadth first search algorithm to select the most likely paths to be tested for each state generated by the DST algorithm.

### CROSS REFERENCE TO RELATED APPLICATIONS

This application claims the benefit of U.S. Provisional Application Ser. No. 60/666,399, filed on Mar. 30, 2005, which is incorporated by reference herein in its entirety.

### FIELD OF THE INVENTION

The present invention relates generally to the field of software testing, and more particularly, to a technique and system for applying a deterministic state testing approach to a system that has been modeled using Unified Modeling Language (UML) use cases and activity diagrams.

### BACKGROUND OF THE INVENTION

The Unified Modeling Language is a language used in software engineering for object modeling and specification. An important feature of UML is the use of a standardized graphical notation to create an abstract model of a system. UML is most commonly used to specify, visualize, construct, and document software-intensive systems.

UML use case modeling and activity diagrams are defined by the Object Management Group (OMG), an international standard committee. Current and past versions of the specification are available from OMG on-line at http://www.uml.org/.

A set of UML diagrams is used to represent a system. Each diagram is a partial graphical representation of a system's model. A UML model typically also contains text documentation such as written use cases that drive the model elements and diagrams.

One diagram frequently used in representing a system in a UML model is the use case diagram. UML use case diagrams are used to represent the functionality of the system from a top-down perspective. Each use case provides one or more scenarios that convey how the system should interact with the end user or with another system to achieve a specific business goal.

A use case can include or extend other use cases. The “include” relationship is used when a use case is contained in another use case. The “extend” relationship is used when a use case may or may not be contained in another use case. The resulting hierarchy can span many use case diagrams.

The example use case diagram 100 of FIG. 1 represents stereo system software capable of running multiple instances of various components, such as may be useful in an airliner cabin entertainment system wherein each passenger may prefer a different configuration of the virtual stereo system. The top level use case 110 STEREO SYSTEM “includes” the POWER UP use case 120. The SET OPTIONS use case 130, the RADIO use case 140 and the CD PLAYER use case 150 all “extend” the STEREO SYSTEM use case 110.

Use cases provide a natural way to break up a large project. In part for that reason, software test cases have been generated from use cases. Having a use case hierarchy permits test case generation to be initiated at different levels.

When modeling for test case generation, each activity preferably has its own activity diagram. If a use case has included or extended another use case, the included or extended use case must be represented in the diagram as an activity of the same name as its corresponding use case. That provides information about the order in which use cases are carried out, and thus permits automation.

FIG. 2 is an example activity diagram 200 representing the top level use case STEREO SYSTEM of the use case diagram 100 of FIG. 1. Because the use case STEREO SYSTEM “includes” the POWER UP use case, there is a POWER UP activity 210 in every path of the activity diagram 200.

The use cases RADIO, SET OPTIONS and CD PLAYER that “extend” the STEREO SYSTEM use case are represented by the activities 240, 250, 260 respectively. Those activities appear on different paths of the activity diagram 200. The path representing a given instance of the STEREO SYSTEM use case is determined in the CHOOSE SOURCE decision 230. All paths terminate at block 270.

The OMG has done work in extending UML to enable performance modeling. See OMG, RFP: UML Profile for Scheduling, Performance, and Time; OMG Document formal/99-03-13, March 1999, found at http://www.omg.org.

Other work has focused on enhancements to UML activity diagrams for performance analysis. In C. Lindemann et al., Performance Analysis of Time-Enhanced UML Diagrams Based on Stochastic Processes, Proc. 3rd Int'l Workshop on Software and Performance (WOSP), Rome, Italy, pp. 25-34 (July 2002), timed events and transition probabilities are added to activity diagrams such that the activity diagram can be mapped to a generalized semi-Markov process, which is solved using numerical methods.

One known approach for the generation and execution of performance tests is Deterministic State Testing (DST). DST is described, for example, in Alberto Avritzer & Elaine J. Weyuker, The Automatic Generation of Load Test Suites and the Assessment of the Resulting Software, 21 IEEE Transactions on Software Engineering 705 (1995), and in Alberto Avritzer and Brian Larson, Load Testing Software Using Deterministic State Testing, Proceedings of the 1993 Int'l Symposium on Software Testing and Analysis (ISSTA) at 82-88 (ACM Press, June 1993), the contents of each being hereby incorporated in their entirety herein. DST uses a high level state definition and an analytical approximation to identify the most likely states in a continuous-time Markov chain representation of the system under test. The most likely states represent the best states to be exercised by performance tests because those states contain the problems that are most likely encountered in production.

Currently, there exists no automated method for the processing of UML use cases to drive the DST tool. Instead, performance test cases are generated by manually specifying the scenarios. That mode of operation requires the manual evaluation of system requirements to extract the performance requirements. For large-scale and even medium-scale systems, that mode is labor-intensive and inefficient.

There is therefore presently a need to provide a method and system for generating performance test cases for testing a software system. The technique should be capable of handling systems having many possible execution paths and configurations, and should be executable on test hardware that is within practical bounds. The technique should lend itself to automation. To the inventors' knowledge, there is currently no such technique available.

### SUMMARY OF THE INVENTION

The present invention addresses the needs described above by providing a method for generating performance test cases for a software system including N independent types of use cases forming a state S=(U₁, U₂, . . . , U_{N}) wherein U_{N} is a number of use cases of type N. In one embodiment of the invention, the method comprises identifying, using a deterministic state test, those states S having a steady-state probability of occurring that is greater than a minimum probability ε; for each identified state S, defining an activity diagram; labeling edges in the activity diagrams with transition probabilities; and searching each activity diagram to identify, as performance test cases, those paths having a probability of occurrence greater than ε.

The step of identifying, using a deterministic state test, those states S having a steady-state probability of occurring that is greater than a minimum probability ε, may further comprise the steps of: incrementing the use case type N through all types of use cases; for each incremented use case type N, incrementing numbers U_{N} of the use case type starting at 1; for each state reached by incrementing the number U_{N}, which state has a probability of occurrence greater than ε or has a ratio λ_{N}/μ_{N}≧1, wherein λ_{N} is denotes an arrival rate for use case type N when there are U_{N} cases and μ_{N} denotes a completion rate for use case type N when there are U_{N} cases, generating performance test cases by recursively applying a deterministic state test; and, if the state reached by incrementing the number U_{N} does not have a probability of occurrence greater than ε or a ratio λ_{N}/μ_{N}≧1, and all case types N have not been incremented, then proceeding to a next case type N.

The step of generating performance test cases may include determining a probability of occurrence of a state by determining a product of probabilities of state transitions leading to the state.

The method may further comprise the step of heuristically determining the minimum probability ε. The step of heuristically determining the minimum probability ε may be based on a predetermined number of performance test cases.

The step of searching each activity diagram may further comprise applying a breadth-first search algorithm to each activity diagram. The step of defining an activity diagram for each identified state S may further comprise defining a Unified Modeling Language (UML) activity diagram.

The method may further comprise the step of executing the identified performance test cases by: for each of the states S identified using a deterministic state test, initiating the number U_{N} of use cases for each use case type; executing paths in a sorted list of most likely paths associated with state S; and validating that state S was reached.

Another embodiment of the invention is a computer program product comprising a computer readable recording medium having recorded thereon a computer program comprising code means for, when executed on a computer, instructing said computer to control steps in a method for generating performance test cases for a software system including N independent types of use cases forming a state S=(U₁, U₂, . . . , U_{N}) wherein U_{N} is a number of use cases of type N, the method comprising the steps of: identifying, using a deterministic state test, those states S having a steady-state probability of occurring that is greater than a minimum probability ε; for each identified state S, defining an activity diagram; labeling edges in the activity diagrams with transition probabilities; and searching each activity diagram to identify, as performance test cases, those paths having a probability of occurrence greater than ε.

The step of identifying, using a deterministic state test, those states S having a steady-state probability of occurring that is greater than a minimum probability ε, may further comprise the steps of incrementing the use case type N through all types of use cases; for each incremented use case type N, incrementing numbers U_{N} of the use case type starting at 1; for each state reached by incrementing the number U_{N}, which state has a probability of occurrence greater than ε or has a ratio λ_{N}/μ_{N}≧1, wherein λ_{N} is denotes an arrival rate for use case type N when there are U_{N} cases and μ_{N} denotes a completion rate for use case type N when there are U_{N} cases, generating performance test cases by recursively applying a deterministic state test; and, if the state reached by incrementing the number U_{N} does not have a probability of occurrence greater than ε or a ratio λ_{N}/μ_{N}≧1, and all case types N have not been incremented, then proceeding to a next case type N.

The step of generating performance test cases may include determining a probability of occurrence of a state by determining a product of probabilities of state transitions leading to the state.

The method may further comprises the step of: heuristically determining the minimum probability. The step of heuristically determining the minimum probability ε may be based on a predetermined number of performance test cases.

The step of searching each activity diagram may further comprise applying a breadth-first search algorithm to each activity diagram. The step of defining an activity diagram for each identified state S may further comprise defining a Unified Modeling Language (UML) activity diagram.

The method may further comprise the step of executing the identified performance test cases by: for each of the states S identified using a deterministic state test, initiating the number U_{N} of use cases for each use case type; executing paths in a sorted list of most likely paths associated with state S; and validating that state S was reached.

### BRIEF DESCRIPTION OF THE DRAWINGS

FIG. 1 is an exemplary UML use case diagram showing an showing a stereo system used as an example in the present specification.

FIG. 2 is a UML activity diagram of the system of the use case diagram of FIG. 1.

FIG. 3 is a block diagram of a computer system suitable for executing a method according to the invention.

FIG. 4A shows a table containing exemplary path probabilities for the use case diagram of FIG. 1.

FIG. 4B is an annotated UML activity diagram according to one embodiment of the invention.

FIG. 5 is flow chart showing a deterministic state testing method according to one embodiment of the invention.

FIG. 6 is flow chart showing a method according to one embodiment of the invention.

FIG. 7 is flow chart showing a method according to one embodiment of the invention.

### DESCRIPTION OF THE INVENTION

The inventors have discovered a quantitative method for automatically generating performance tests when an application is modeled using UML use case models and activity diagrams. A methodology is presented below for integrating UML use case models and activity diagrams with DST. Additionally, an integrated methodology is presented for performance test case generation and execution for systems that are modeled using UML use cases and UML activity diagrams.

The invention is a modular framework and method and is deployed as software as an application program tangibly embodied on a program storage device. The application is accessed through a graphical user interface (GUI). The application code for execution can reside on a plurality of different types of computer readable media known to those skilled in the art. Users access the framework by accessing the GUI via a computer.

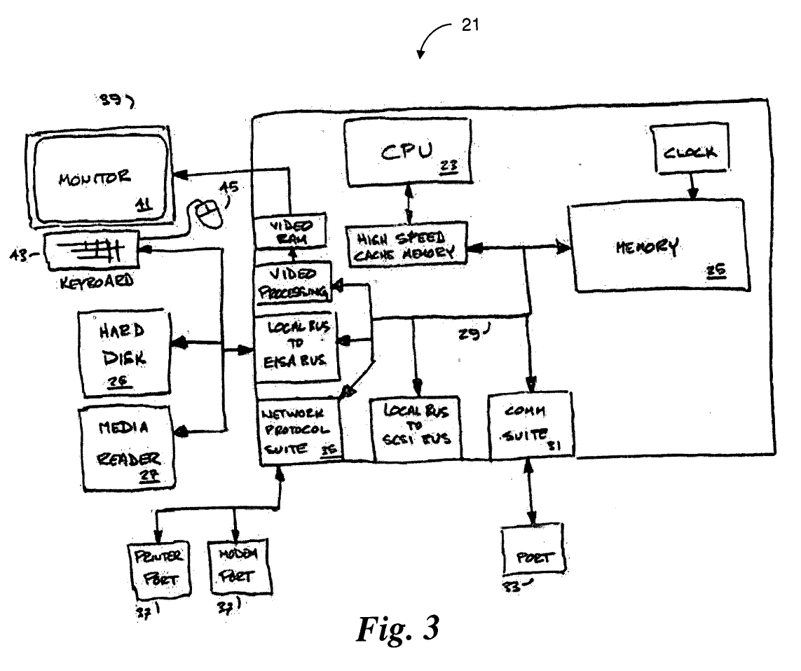

An embodiment of a computer 21 executing the instructions of an embodiment of the invention is shown in FIG. 3. A representative hardware environment is depicted which illustrates a typical hardware configuration of a computer. The computer 21 includes a CPU 23, memory 25, a reader 27 for reading computer executable instructions on computer readable media, a common communication bus 29, a communication suite 31 with external ports 33, a network protocol suite 35 with external ports 37 and a GUI 39.

The communication bus 29 allows bi-directional communication between the components of the computer 21. The communication suite 31 and external ports 33 allow bi-directional communication between the computer 21, other computers 21, and external compatible devices such as laptop computers and the like using communication protocols such as IEEE 1394 (FireWire or i.LINK), IEEE 802.3 (Ethernet), RS (Recommended Standard) 232, 422, 423, USB (Universal Serial Bus) and others.

The network protocol suite 35 and external ports 37 allow for the physical network connection and collection of protocols when communicating over a network. Protocols may include TCP/IP (Transmission Control Protocol/Internet Protocol) suite, IPX/SPX (Internetwork Packet eXchange/Sequential Packet eXchange), SNA (Systems Network Architecture), and others. The TCP/IP suite includes IP (Internet Protocol), TCP (Transmission Control Protocol), ARP (Address Resolution Protocol), and HTTP (Hypertext Transfer Protocol). Each protocol within a network protocol suite has a specific function to support communication between computers coupled to a network. The GUI 39 includes a graphics display such as a CRT, fixed-pixel display or others 41, a key pad, keyboard or touchscreen 43 and pointing device 45 such as a mouse, trackball, optical pen or others to provide an easy-to-use, user interface for the invention.

The computer 21 may be a conventional personal computer such as a PC, Macintosh, or UNIX based workstation running their appropriate OS (Operating System) capable of communicating with a computer over wireline (guided) or wireless (unguided) communications media. The CPU 23 executes compatible instructions or software stored in the memory 25. Those skilled in the art will appreciate that the invention may also be practiced on platforms and operating systems other than those mentioned.

The inventors propose to annotate the use case model with arrival rates and departure rates, and to automatically generate test scenarios from activity diagrams. The test scenarios are then used to test each state generated by DST.

The overall approach comprises assigning arrival rates and departure rates for each of the components of the UML use case model and applying the DST algorithm to generate and execute test cases for performance testing. For each state S, generated by the DST algorithm, the technique of the invention uses the following overall methodology to validate state S:

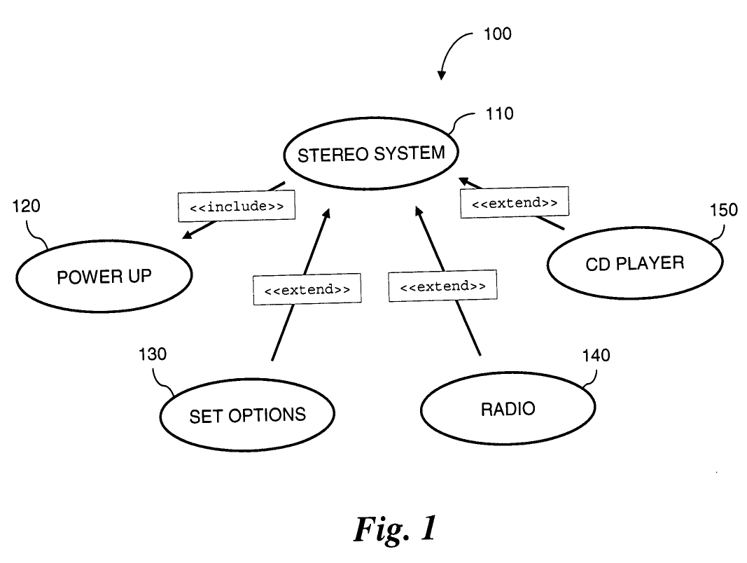

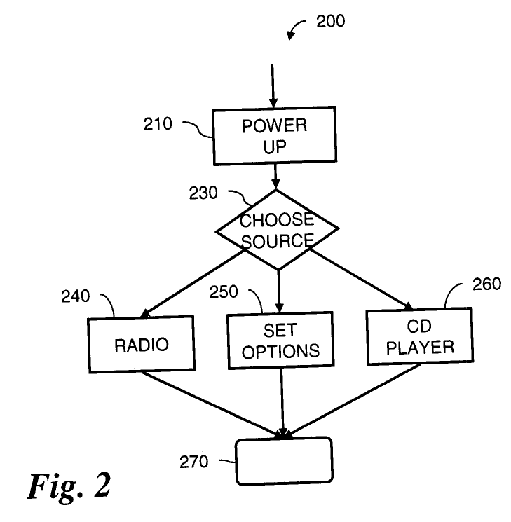

1. Each state S=(U₁, U₂, . . . , U_{N}) is formed by initiating U, use cases of type 1, U₂ use cases of type 2, and U_{N} use cases of type N. For example, referring to the exemplary airline cabin stereo system of FIG. 1, a state S=(30) of the stereo system might represent 30 passengers executing the POWER UP use case.

2. Each use case is refined into a UML activity diagram.

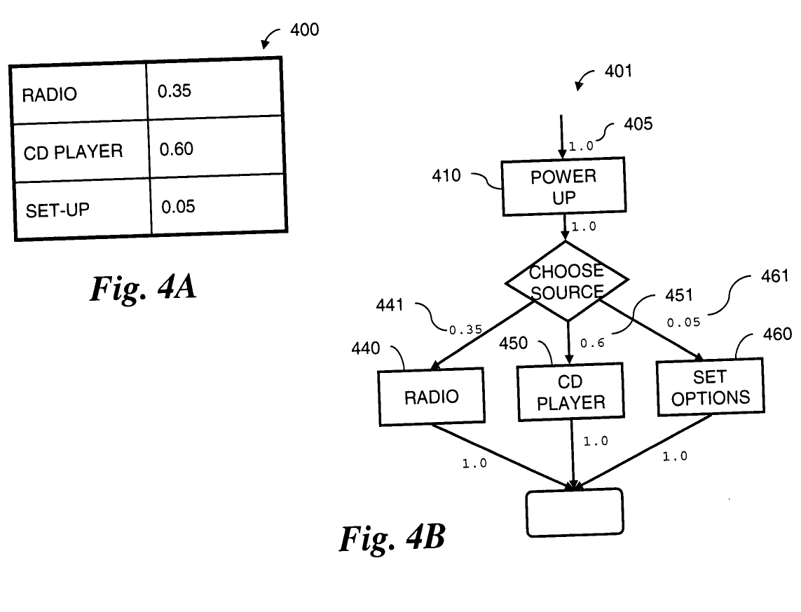

3. Each activity diagram is transformed by labeling each edge with a transition probability. FIG. 4B shows an activity diagram 401 for the top level use case STEREO SYSTEM labeled with transitional probabilities from a table 400, shown in FIG. 4A. For example, every path of the STEREO SYSTEM activity diagram 401 invokes the included POWER UP use case 410, so a probability 405 of that use case is 1.0. On the other hand, a given path invokes only one of the RADIO, CD PLAYER and SET OPTIONS use cases 440, 450, 460 according to the probabilities shown in table 400. Those probabilities are labeled at 441, 451, 461.

4. For each activity diagram, a breadth first search algorithm is used to extract a sorted list of most likely paths required to cover the activity diagram up to a total probability (1−ε), where ε is a small number that describes the total discarded path probability. ε is a heuristically computed probability. Typically, a small value for ε is initially chosen. That value is tuned upward until the number of test cases is approximately equal to a number indicated by the testers as feasible to perform. The tuning of ε may be done using a binary search.

Whenever a use case requires execution, the next path in the sorted list of most likely paths, associated with the use case, is selected.

The method of the present invention uses a decomposition approach for test case generation and execution. A DST algorithm is used for test case generation and execution based on the use case model definition. Each edge in the activity diagram generated for each use case, is labeled with a transition probability. Therefore, a breadth-first search algorithm can be used to generate the most likely scenarios, for each activity diagram. During test case execution, the mostly likely scenarios are tested, one at a time, whenever a certain use case is specified as part of the state under test.

An exemplary Deterministic State Testing (DST) algorithm suitable for use in the present invention is described in Avritzer & Weyuker, supra. The strategy used by that algorithm is to generate all states having a steady-state probability greater than ε.

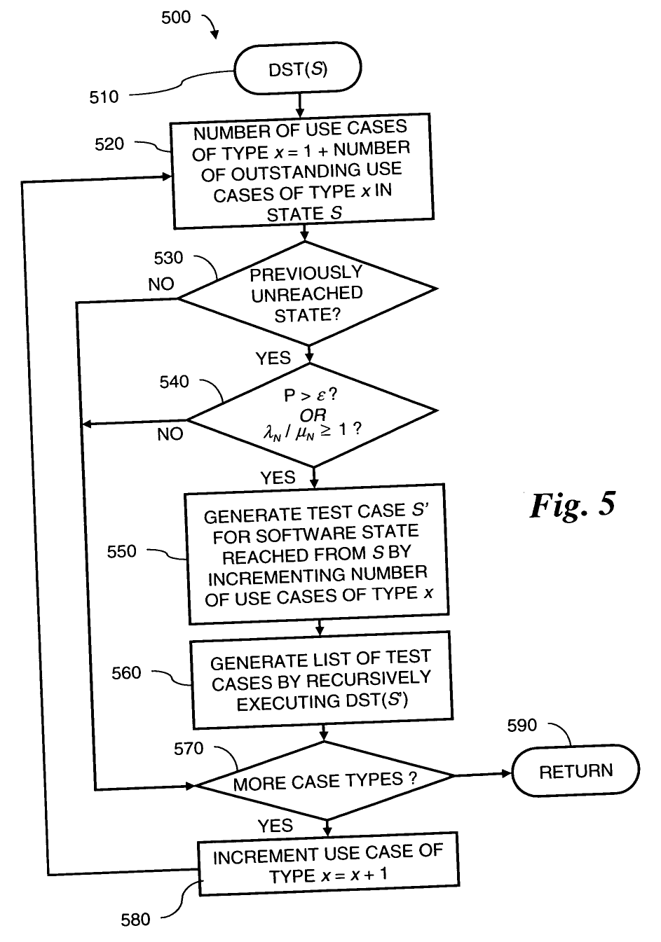

The algorithm 500, shown in FIG. 5, generates a list of test cases starting from the software state S and incrementing through each use case type up to use case type N. The algorithm is initialized by setting an index x representing a use case type to 1, and setting the state S to (0, 0, . . . , 0) (step 510). The algorithm DST(S) is then started (step 510).

The number of use cases N of type x is also initially set to 1 plus the number of outstanding use cases of type x in state S (step 520). That number is incremented for each iteration of the algorithm for state S.

Next it is determined whether, by adding one more instance of use case type x, a previously unreached state is reached (decision 530). If not, that state is discarded and the method continues to the next use case type.

If a previously unreached state is reached (decision 530), then it is determined whether the steady-state probability P of the state so generated is greater than ε or the generated state has a ratio λ_{N}/μN≧1 (decision 540), where λ_{N} denotes an arrival rate when there are N active use cases of type x, and λ_{N} denotes a completion rate when there are N active use cases of type x. If either case is true, the algorithm continues to step 550 as described below. If not, that state is discarded and the method continues (step 580) to the next use case type. States with probabilities less than λ and having a ratio λ_{N}/μ_{N}<1 are discarded because all states generated from those states are guaranteed to have probabilities less than ε. If the ratio λ_{N}/μ_{N}≧1, however, a probability less than ε associated with a state does not necessarily imply that successor states will have a probability less than ε, so those states are not discarded.

For states in which the above criteria are met, a test case S′ is generated (step 550) for the software state reached from S by adding one or more use cases of type x. A list of test cases is generated (560) by recursively executing the DST algorithm on S′.

If there are more use case types (decision 570), then the use case type counter x is incremented (step 580) and the method continues. If all use case types have been considered, the method ends (step 590).

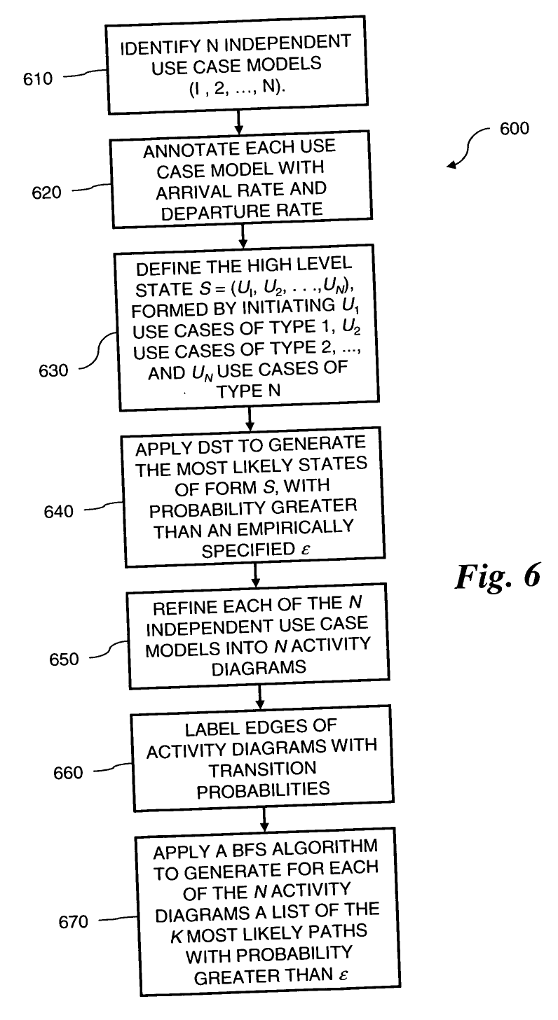

The inventors have utilized the above DST algorithm for the generation of performance test cases from UML use case diagrams and annotated activity diagrams, as described here with reference to the technique 600 of FIG. 6. N independent use case types are initially identified (step 610). The use cases may be indexed for identification, such as (1, 2, . . . , N). Each of the use cases is annotated (step 620) with an arrival rate and a departure rate. For example, in the case of the airplane cabin stereo system, the RADIO use case may be annotated with 30 instances per hour where a passenger chooses the RADIO use case, and 25 instances per hour in which a passenger terminates a RADIO use case. At full capacity, arrival rates and departure rates are equal.

The high level state S=(U₁, U₂, . . . , U_{N}) is defined (step 630). The state S is formed by initiating U₁ use cases of type 1, U₂ use cases of type 2, . . . , and U_{N} use cases of type N.

A DST algorithm, such as that described above, is applied (step 640) to generate the most likely states of form S, with probability greater than an empirically specified ε. Each of the N independent use case models generated using the DST algorithm is refined (step 650) into N activity diagrams.

The edges of those activity diagrams are labeled (step 660) with transition probabilities, as discussed above with reference to FIGS. 4A and 4B. A breadth-first search (BFS) algorithm is applied (step 670) to generate for each of the N activity diagrams a list of the K most likely paths with probability greater than ε. Therefore, for activity diagram I, K_I most likely paths will be generated.

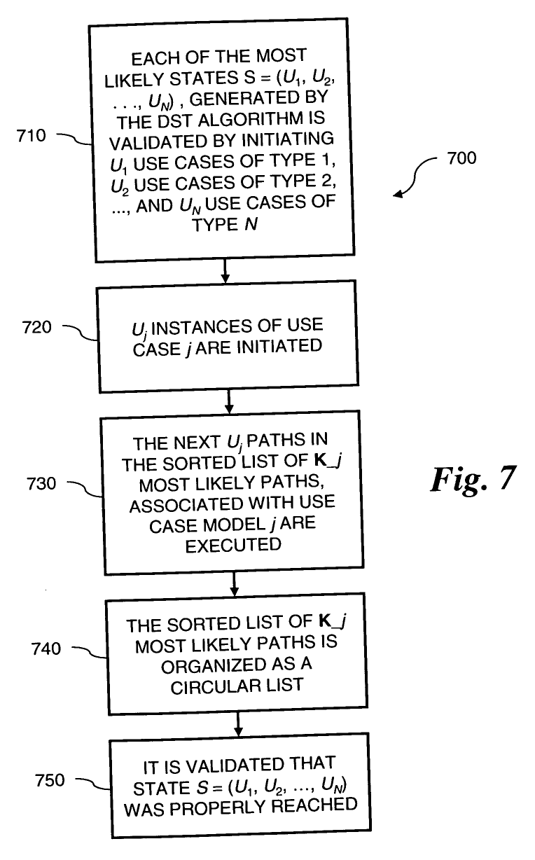

After performance test cases are generated using the above-described technique, performance testing test case execution is done using the method 700 shown in FIG. 7. Each of the most likely states S=(U₁, U₂, . . . , U_{N}), generated by the DST algorithm above, is validated (step 710) by initiating U₁ use cases of type 1, U₂ use cases of type 2, . . . , and U_{N} use cases of type N.

To initiate Uⱼ operations of type j, Uⱼ instances of use case j are initiated (step 720) as follows: the next Uⱼ paths in the sorted list of K_j most likely paths, associated with use case model j are executed (step 730). The sorted list of K_j most likely paths is organized (step 740) as a circular list. It is then validated (step 750) that state S=(U₁, U₂, . . . , U_{N}) was properly reached.

The present invention enables full automation of the performance test case generation process. The technique integrates with the activity diagram and therefore allows for the full automation of the execution process as well. Most application domains in software engineering are currently developing requirements in UML that include use case models and activity diagrams. The invention can therefore be applied to a variety of domains like conveyer belts, medical systems, transportation systems, power generation and power transmission systems.

The invention may be generalized by using different ways of verifying that state S was properly reached. For example, in one embodiment of the invention, all paths to the state S in the Markov chain generated by DST are tests. Additionally, the time expended in testing each state may be varied by requiring different amounts of testing effort per state.

In another embodiment of the invention, all paths in the sorted list of K_j most likely paths, associated with use case model j, would be tested every time use case model j is invoked in a state. That version requires more effort than other described embodiments, but may be economical to test simple activity diagrams.

The invention may be applied to the automatic generation and execution of performance tests that could be used to validate the performance requirements of logistics and assembly products.

The automatic performance test case generation of the invention, which derives DST testing from UML use case models, is a more cost effective approach than the current mode of operation; i.e., manual evaluation of requirements to identify performance tests. It can be integrated in a more cost effective way into standard software development processes than the current mode of operation.

The foregoing Detailed Description is to be understood as being in every respect illustrative and exemplary, but not restrictive, and the scope of the invention disclosed herein is not to be determined from the Description of the Invention, but rather from the Claims as interpreted according to the full breadth permitted by the patent laws. For example, while the method is disclosed herein in conjunction with the testing of software systems, the method is also applicable to other complex systems such as business or manufacturing systems that are not necessarily embodied in software code, while remaining within the scope of the invention. It is to be understood that the embodiments shown and described herein are only illustrative of the principles of the present invention and that various modifications may be implemented by those skilled in the art without departing from the scope and spirit of the invention.

What is claimed is:

1. A method for generating performance test cases for a software system including N independent types of use cases forming a state S=(U₁, U₂, . . . , U_{N}) wherein U_{N} is a number of use cases of type N, the method comprising the steps of:
identifying, using a deterministic state test, those states S having a steady-state probability of occurring that is greater than a minimum probability ε;
for each identified state S, defining an activity diagram;
labeling edges in the activity diagrams with transition probabilities; and
searching each activity diagram to identify, as performance test cases, those paths having a probability of occurrence greater than ε.

2. The method of claim 1, wherein the step of identifying, using a deterministic state test, those states S having a steady-state probability of occurring that is greater than a minimum probability ε, further comprises the steps of:
incrementing the use case type N through all types of use cases;
for each incremented use case type N, incrementing numbers U_{N} of the use case type starting at 1;
for each state reached by incrementing the number U_{N}, which state has a probability of occurrence greater than ε or has a ratio λ_{N}/μ_{N}≧1, wherein λ_{N} is denotes an arrival rate for use case type N when there are U_{N} cases and μ_{N} denotes a completion rate for use case type N when there are U_{N} cases, generating performance test cases by recursively applying a deterministic state test; and
if the state reached by incrementing the number U_{N} does not have a probability of occurrence greater than ε or a ratio λ_{N}/μ_{N}≧1, and all case types N have not been incremented, then proceeding to a next case type N.

3. The method of claim 2, wherein the step of generating performance test cases includes:
determining a probability of occurrence of a state by determining a product of probabilities of state transitions leading to the state.

4. The method of claim 1, further comprising the step of:
heuristically determining the minimum probability ε.

5. The method of claim 5, wherein the step of heuristically determining the minimum probability ε is based on a predetermined number of performance test cases.

6. The method of claim 1, wherein the step of searching each activity diagram further comprises applying a breadth-first search algorithm to each activity diagram.

7. The method of claim 1, wherein the step of defining an activity diagram for each identified state S further comprises defining a Unified Modeling Language (UML) activity diagram.

8. The method of claim 1, further comprising the step of executing the identified performance test cases by:
for each of the states S identified using a deterministic state test, initiating the number U_{N} of use cases for each use case type;
executing paths in a sorted list of most likely paths associated with state S; and
validating that state S was reached.

9. A computer program product comprising a computer readable recording medium having recorded thereon a computer program comprising code means for, when executed on a computer, instructing said computer to control steps in a method for generating performance test cases for a software system including N independent types of use cases forming a state S=(U₁, U₂, . . . , U_{N}) wherein U_{N} is a number of use cases of type N, the method comprising the steps of:
identifying, using a deterministic state test, those states S having a steady-state probability of occurring that is greater than a minimum probability ε;
for each identified state S, defining an activity diagram;
labeling edges in the activity diagrams with transition probabilities; and
searching each activity diagram to identify, as performance test cases, those paths having a probability of occurrence greater than ε.

10. The computer program product of claim 9, wherein the step of identifying, using a deterministic state test, those states S having a steady-state probability of occurring that is greater than a minimum probability ε, further comprises the steps of:
incrementing the use case type N through all types of use cases;
for each incremented use case type N, incrementing numbers U_{N} of the use case type starting at 1;
for each state reached by incrementing the number U_{N}, which state has a probability of occurrence greater than ε or has a ratio λ_{N}/U_{N}≧1, wherein λ_{N} is denotes an arrival rate for use case type N when there are U_{N} cases and λ_{N} denotes a completion rate for use case type N when there are U_{N} cases, generating performance test cases by recursively applying a deterministic state test; and
if the state reached by incrementing the number U_{N} does not have a probability of occurrence greater than ε or a ratio λ_{N}/μ_{N}≧1, and all case types N have not been incremented, then proceeding to a next case type N.

11. The computer program product of claim 10, wherein the step of generating performance test cases includes:
determining a probability of occurrence of a state by determining a product of probabilities of state transitions leading to the state.

12. The computer program product of claim 9, wherein the method further comprises the step of:
heuristically determining the minimum probability ε.

13. The computer program product of claim 12, wherein the step of heuristically determining the minimum probability ε is based on a predetermined number of performance test cases.

14. The computer program product of claim 9, wherein the step of searching each activity diagram further comprises applying a breadth-first search algorithm to each activity diagram.

15. The computer program product of claim 9, wherein the step of defining an activity diagram for each identified state S further comprises defining a Unified Modeling Language (UML) activity diagram.

16. The computer program product of claim 9, wherein the method further comprises the step of executing the identified performance test cases by:
for each of the states S identified using a deterministic state test, initiating the number U_{N} of use cases for each use case type;
executing paths in a sorted list of most likely paths associated with state S; and
validating that state S was reached.
